(19) United States
(12) Patent Application Publication
(10) Pub. No.: US 2006/0108553 A1
(43) Pub. Date: May 25, 2006

(54) Quick connect angle stop device

(76) Inventor: Anthony Mora, Miami, FL (US)

Correspondence Address: Anthony Mora, 19140 ROYAL BIRKDALE DRIVE, MIAMI, FL, 33015, US

(21) Appl. No.: 10/993,503

(22) Filed: Nov. 22, 2004

(51) Int. Cl. F16L 29/00

(52) U.S. Cl. 251/148

(57) ABSTRACT

A shut-off device for connection to a water supply line has a first open end, a second open end, a fluid passage between the open ends and a valve assembly for selectively interrupting fluid flow through the passage. A clamp section adjacent to the first open end provides a secure, strong and water tight connection of the device to a water supply line. The clamp section includes an interior wall surface sized for axial receipt of an end portion of the water supply line therein. At least one 0-ring is fitted to the interior wall surface for sealed engagement about the exterior surface of the water supply line. One or more set screws are threadably fitted through the wall structure of the clamp section and include a flat distal end for forceably engaging the exterior surface of the water supply line to fix the device in water tight connection to the water supply line.

### BACKGROUND OF THE INVENTION

1. Field of the Invention

This invention relates to a water supply cut-off device and, more particularly, to an angle stop which is easy to connect and disconnect from a water supply line to provide a secure, strong and water tight connection without soldering.

2. Discussion of the Related Art

Angle stops, shut-off valves, and other similar devices are often used between a water supply line and various water delivery items and fixtures such as faucets, toilets, cooling units, ice makers, etc., in order to interrupt water flow to these fixtures for various purposes, such as when there is a need to repair or replace the fixture.

Ordinary plumbing angle stops and similar devices must be soldered to copper supply lines. In most instances, a plumber is needed to make the soldered connection. When a plumbing shut-off valve (angle stop) is connected to a copper supply line, it is necessary to clean both the valve connector end and the supply copper tube and then skillfully apply flux and solder to the contact surfaces in order to insure a secure and water tight connection which will not leak when under pressure.

The present invention provides a novel angle stop device which is easily connected to an annular metal fitting, such as a water supply line, for either permanent or temporary connection. The angle stop device of the present invention avoids the use of solder and uses one or more O-rings to provide a hydrostatic seal adapted to withstand approximately 80 pounds of water pressure. One or more set screws are used to provide a strong mechanical, clamping connection of the device to the water supply line without puncturing the supply line.

### SUMMARY OF THE INVENTION

The present invention is directed to a quick connect shut-off device for a water supply line. More particularly, a clamp structure provides for a quick and water-tight connection of a cut-off valve or angle stop device to a water supply line without the need for soldering. The clamp section is an integral part of the overall device which includes the cut-off valve or angle stop. The clamp section of the device is fitted with one or more Viton O-rings, or similar type O-rings, fitted in precisely cut grooves to provide a water-tight seal about a water supply line (e.g. a copper tube) and an angle stop or similar cut-off device. The clamp section extends from the angle stop (i.e. cut-off valve) and is locked onto the water supply line with one or more flattened set screws. The set screws are designed to prevent penetration through the water supply line. More particularly, the set screws include roughened flat end surfaces which engage the outer surface of the water supply line received within the device, thereby providing significant holding power without puncturing the water supply line. Positioning the set screws outboard of the O-ring seals provides a reliable and leak proof means for securing the shut-off device of the present invention to the water supply line. Specifically, an undesirable inboard set screw location, between the O-ring seals and the shut-off valve, can result in water leakage. Accordingly, it is preferred to locate the one or more set screws outboard of the O-ring seals.

### OBJECTS AND ADVANTAGES OF THE INVENTION

Considering the foregoing, it is a primary of the present invention to provide a shut-off device for quick and easy connection to a water supply line without the need for soldering or special tools.

It is a further object of the present invention to provide a fast method to connect water supply lines to an angle stop or other similar shut-off devices.

It is still a further object of the present invention to provide a strong, water tight and non-soldered tube connection between a water supply tube (e.g. copper tubing) and a shut-off device.

It is still a further object of the present invention to provide a safe non-toxic, lead free, non-polluting and solderless method of connecting water supply lines to angle stop valves or similar shut-off devices.

It is still a further object of the present invention to provide an angle stop or shut-off device for connection to a water supply line and wherein the device includes a clamp section with hydrostatic seal for providing a secure, water-tight connection which eliminates the use of toxic solder, toxic lead soldering fumes and heat for making the connection.

It is still a further object of the present invention to provide a shut-off device for connection to a water supply line which includes a clamp section structured and disposed for providing a hydrostatic sealed connection to a water supply line within a few seconds, thus saving considerable time and expense.

It is still a further object of the present invention to provide a shut-off device for quick and easy connection to a water supply line and wherein the device can be installed by an ordinary person, such as a homeowner, thus eliminating the need for a skilled plumber to make the connection.

It is still a further object of the present invention to provide a clamp section with a hydrostatic seal on a water shut-off device, and wherein the clamp section provides for fast disconnecting as well as reconnecting to a water supply line, thus simplifying repair or replacement of fixtures and other items connected to the water supply line and plumbing system.

It is still a further object of the present invention to provide a water shut-off device for connection to a water supply line, and wherein the device includes a clamp section with a hydrostatic seal which attaches at room temperature, without any heating, thus preventing the possibility of damage to heat sensitive decorative plumbing fixtures.

It is still a further object of the present invention to provide a shut-off device for connection to a water supply line, wherein the device includes a clamp section with a hydrostatic seal and one or more high friction flat end set screws which provide a firm hold on the water supply line while avoiding penetration through the supply line and possible leakage.

These and other objects and advantages of the present invention are more readily apparent with reference to the detailed description and accompanying drawings.

### BRIEF DESCRIPTION OF THE DRAWINGS

For a fuller understanding of the nature of the present invention, reference should be made to the following detailed description taken in conjunction with the accompanying drawings in which:

FIG. 1 is a side elevational view, in cross-section, showing the shut-off device of the present invention, in accordance with a preferred embodiment thereof, with a water supply line separated from a first open end of the device and ready for insertion therein to subsequently secure the shut-off device to an end of the water supply line;

FIG. 2 is a side elevational view, in cross section, showing the shut-off device of FIG. 1 with the end portion of the water supply line received through the open end of the device and within a clamp section of the device for secure, water tight connection;

FIG. 3 is an exterior side elevational view showing the shut-off device of FIG. 1 connected to the end portion of the water supply line;

FIG. 4-A is an end elevational view, in partial cross-section, taken along the plane of the line indicated as 4-4 in FIG. 3;

FIG. 4-B is and end elevational view, in partial cross-section, taken along the plane indicated as 4-4 in FIG. 3 and showing an alternative arrangement of set screws for securing the shut-off device to the water supply line;

FIG. 5 is a side elevational view, in cross-section, showing the shut-off device secured to the end portion of the water supply line, and wherein the clamp section of the shut-off device is provided with two spaced apart O-rings for providing a sealed connection between the shut-off device and the exterior surface of the water supply line; and

FIG. 6 is a bottom plan view of the shut-off device of FIG. 5 shown in connection with the water supply line.

Like reference numerals refer to like parts throughout the several views of the drawings.

### DETAILED DESCRIPTION OF THE PREFERRED EMBODIMENTS

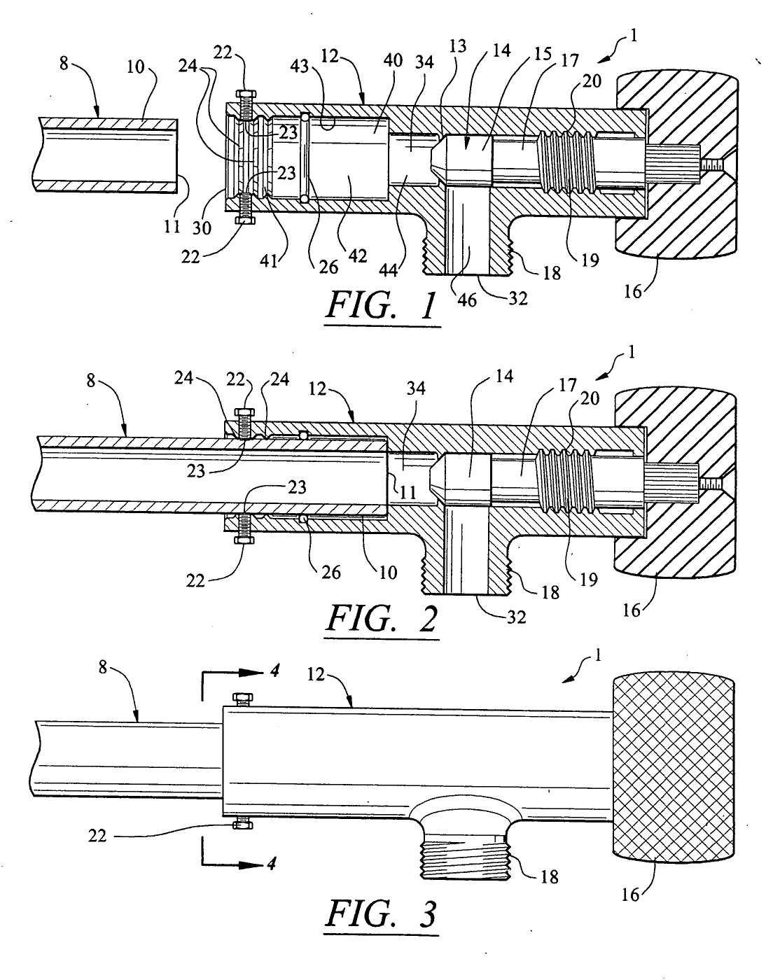

Referring to the several views of the drawings, and initially FIGS. 1-3, the shut-off (e.g. angle stop) device of the present invention is shown and is generally indicated as 1. The shut-off device 1 is specifically intended for connection to a water supply line 8, such as copper tubing. More specifically, the shut-off device 1 connects to an end portion 10 of the water supply line 8.

The shut-off device 1 includes a main body 12 having a first open end 30, a second open end 32 and a fluid passage 34 extending between the first and second open ends. The main body 12 may be formed of any of a variety of metals, ceramic, plastic or other suitable materials. The first open end 30 communicates with an input channel 42 sized and configured for receipt of the end portion 10 of the water supply line therein. More specifically, the inner diameter of the input channel 42, defined by a surrounding interior wall surface 43, is larger than the exterior dimension (e.g. diameter) of the end portion 10 of the water supply line 8. When the end portion 10 of the water supply line 8 is received within the input channel 42, an open end 11 of the water supply line is positioned adjacent a fluid receiving chamber 44 which extends from the input channel 42. The input channel 42 and fluid receiving chamber 44 together define a first portion of the fluid passage 34. A second portion 46 of the fluid passage 34 extends downwardly to the second open end 32.

A valve assembly 14 is provided for interrupting fluid flow through the fluid passage 34 in order to control discharge of fluid from the second open end 32. More specifically, the valve assembly 14 is structured to stop fluid flow from the first portion 40 of the fluid passage 34 and into the second portion 46 of a fluid passage 34. The valve assembly includes a valve seat 13 integrally formed with the main body 12 of the device, between the fluid receiving chamber 44 and the second portion 46 of the fluid passage 34. A valve head 15 is movable relative to the valve seat 13 to selectively interrupt fluid flow through the fluid passage. More specifically, the valve head 15 is movable into sealed engagement with the valve seat 13, as seen in FIGS. 1, 2 and 5, to stop fluid flow from entering into the second portion 46 of the fluid passage 34, thus interrupting discharge from the second open end 32. The valve head 15 is movable away from sealed engagement with the valve seat to permit fluid flow through the entire fluid passage 34, from the first portion 40 and into the second portion 46 for subsequent discharge from the second open end 32. A rod 17 connects to the valve head 15 and extends outwardly from an end of the main body. A handle 16 is fitted to the end of the rod, on an exterior of the main body. Cooperating screw threads 19 on the rod and 20 on the interior surface of the main body direct screw threaded advancement and withdrawal of the stem 17 and valve head 15 relative to the valve seat 13 upon manual turning of the handle 16.

The input channel 42 includes a clamp section 41 adjacent the first open end 30. In a preferred embodiment, the internal wall surface surrounding the clamp section 41 includes threads 24 for threadably engaging the exterior surface of the end portion 10 of the water supply line 8. At least one O-ring seal 26, fitted within an annular groove formed in the wall surface 43 is adapted for sealed engagement about the exterior surface of the end portion 10 of the water supply line 8, as best seen in FIG. 2. Once the end portion 10 of the water supply line is fully inserted into the input channel 42, as seen in FIG. 2, set screws 22 are threadably advanced, inward, so that flat roughened ends 23 of the set screws forceably engage the exterior surface of the water supply line 8 to provide a tight, clamp fitted attachment of the housing 12 to the water supply line 8 with the one or more O-rings 26 maintaining a water-tight seal about the outer surface of the water supply line 8 so that water traveling through the water supply line and exiting the open end 11 into the fluid passage 34 is not able to leak out from the first open end 30.

The exterior surface of the main body 12 surrounding the second open end 32 may be provided with screw threads 18 for attaching an external device in fluid communication with the second open end 32 and the fluid passage 34, and particularly the second portion 46.

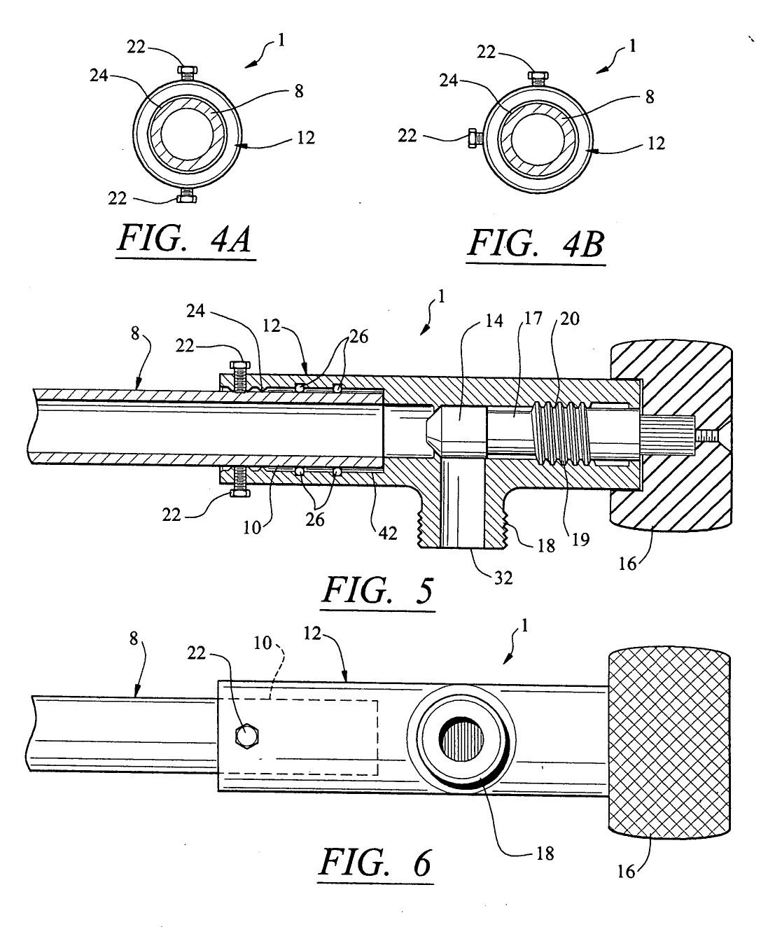

FIGS. 4-A and 4-B show alternative positioning of the set screws 22. Specifically, FIG. 4-A shows positioning of the set screws 22 in accordance with a first preferred embodiment, wherein the set screws are positioned 180 degrees opposite relative to one another, for clamping inwardly on the opposite top and bottom surfaces of the exterior of the water supply line. FIG. 4-B shows an alternative arrangement, wherein the set screws 22 are positioned 90 degrees relative to one another.

FIG. 5 shows an alternative embodiment, wherein multiple O-ring seals 26 are provided within the clamp section. Specifically, two spaced apart O-rings 26 are provided to insure a water tight, sealed engagement between the device 1 and the exterior surface of the end portion 8 of the water supply line 10 received within the input channel 42 of the device.

While the present invention has been shown and described in accordance with various preferred and practical embodiments thereof, it is recognized that departures from the instant disclosure are contemplated within the spirit and scope of the present invention which is not to be limited except as defined in the following claims as interpreted under the Doctrine of Equivalents.

What is claimed is:

1. A shut-off device for connection to a water supply line having an end portion, said device comprising:
a main body having a first open end, a second open end and a fluid passage between said first and second open ends;
a valve assembly for selectively interrupting fluid flow through said fluid passage in order to control discharge of fluid from said second open end;
a clamp section extending from said first open end and including a wall structure with an interior wall surface surrounding an input channel, said input channel defining a portion of said fluid passage and said first open end and said input channel being sized for axial receipt of the end portion of the water supply line therein;
at least one O-ring seal fitted to said interior wall surface for sealed engagement about the exterior surface of the end portion of the water supply line received within the input channel of the clamp portion; and
at least one set screw threadably fitted through said wall structure of said clamp section and including a flat distal end for forceably engaging the exterior surface of the end portion of the water supply line received within the input channel.

2. The device as recited in claim 1 further comprising:
screw threads on said interior wall structure for threaded engagement with the end portion of the water supply line.

3. The device as recited in claim 1 wherein said valve assembly comprises:
a valve seat surrounding said fluid passage; and
a valve head moveable relative to said valve seat, and said valve head being moveable into sealed engagement with said valve seat to stop fluid flow through said fluid passage, thereby stopping discharge of fluid from said second open end, and said valve head being moveable away from sealed engagement with said valve seat to permit fluid flow through said fluid passage for discharge from said second open end.

4. The device as recited in claim 3 wherein said valve assembly further comprises:
a rod connected to said valve head and extending outwardly from said main body;
a handle fitted to an end of said rod exterior of said main body; and
cooperating screw threads on said rod and said main body for directing screw threaded advancement and withdrawal of said stem and said valve head relative to said valve seat upon turning said handle.

5. The device as recited in claim 1 further comprising:
screw thread attachment means on said main body, adjacent to said second open end, for attaching an external device in fluid communication with said second open end.

6. A shut-off device for connection to a water supply line having an end portion, said device comprising:
a main body having a first open end for communicating with an input channel, and a second open end communicating with a discharge channel, said input channel and said discharge channel being disposed in fluid communicating relation to define a fluid passage between said first open end and said second open end;
a valve assembly for selectively interrupting fluid flow through said fluid passage in order to control discharge of fluid through said discharge channel and out from said second open end;
said input channel including a first section extending inwardly from said first open end and surrounded by an interior wall surface, and said first open end and said first section of said input channel being sized for axial receipt of the end portion of the water supply line therein;
at least one O-ring seal fitted to said interior wall surface for sealed engagement about the exterior surface of the end portion of the water supply line received within said first section of said input channel; and
at least one set screw threadably fitted to said main body and including a flat distal end for forceably engaging the exterior surface of the end portion of the water supply line received within said first section of said input channel.

7. The device as recited in claim 6 further comprising:
screw threads on said interior wall structure for threaded engagement with the end portion of the water supply line.

8. A device as recited in claim 6 wherein said valve assembly comprises:
a valve seat surrounding said fluid passage; and
a valve head moveable relative to said valve seat, and said valve head being moveable into sealed engagement with said valve seat to stop fluid flow through said fluid passage, thereby interrupting fluid flow through said discharge channel and out from said second open end, and said valve head being moveable away from sealed engagement with said valve seat to permit fluid flow through said discharge channel for discharge from said second open end.

9. The device as recited in claim 8 wherein said valve assembly further comprises:
a rod connected to said valve head and extending outwardly from said main body;
a handle fitted to an end of said rod exterior of said main body; and
cooperating thread means on said rod and said main body for directing screw threaded advancement and withdrawal of said stem and said valve head relative to said valve seat upon turning said handle.

10. The device as recited in claim 6 further comprising:
screw thread attachment means on said housing, adjacent to said second open end, for attaching an external device in fluid communication with said second open end.
